(19) United States
(12) Patent Application Publication
(10) Pub. No.: US 2025/0245960 A1
(43) Pub. Date: Jul. 31, 2025

(54) ARTIFICIAL INTELLIGENCE-BASED IMAGE PROCESSING METHOD, APPARATUS AND COMPUTER PROGRAM USING EXAMPLE IMAGE DATA

(71) Applicant: D.notitia Inc., Seoul (KR)

(72) Inventors: Moo-Kyoung Chung, Seoul (KR); Seungjae Lee, Seoul (KR)

(21) Appl. No.: 19/011,949

(22) Filed: Jan. 7, 2025

(30) Foreign Application Priority Data
Jan. 26, 2024 (KR) 10-2024-0012195

(51) Int. Cl. G06V 10/70; G06T 3/40; G06T 5/70

(52) U.S. Cl. CPC G06V 10/70; G06T 3/40; G06T 5/70

(57) ABSTRACT

Provided is an artificial intelligence-based image processing method includes a method performed by a computing device and including acquiring input image data to be processed, acquiring example image data corresponding to the acquired input image data, and generating processed image data corresponding to the acquired input image data by inputting the acquired input image data and the acquired example image data into a pre-trained image processing model.

### CROSS-REFERENCE TO RELATED APPLICATION

This application claims priority to Korean Patent Application No. 10-2024-0012195, filed in the Korean Intellectual Property Office on Jan. 26, 2024, the entire contents of which are hereby incorporated by reference.

### BACKGROUND

### Field

The present disclosure relates to an artificial intelligence-based image processing technology, and more specifically, to an artificial intelligence-based image processing method, apparatus, and computer program using an example image.

### Description of Related Art

The constant advancements in camera-related technologies have made it possible to acquire high-resolution images relatively easily and have also enabled cloud-based large video sharing. As a result, interest in acquiring images with excellent quality is also significantly increasing.

However, despite the technological advancements, there remain difficulties in acquiring high-definition images for various reasons such as long exposure times or irregular indoor and outdoor lighting environments. To solve this problem, researches have been continuously conducted in the field of computer vision on software solutions as well as improvements in lenses and hardware configurations, and as a representative example, there is a method of processing images using a deep learning-based model.

The method of processing images using the deep learning-based model involves use of a model that is trained through supervised learning using, as the training data, original image data and result of processing the original image data, in which specific image data is input to the deep learning-based model and processed image data corresponding to the specific image data is acquired as output.

Meanwhile, the method of using the deep learning-based model has a problem that it is difficult to process all images with high performance if the input images for processing are composed of different types of images, and that it is necessary to build individual models for each type of image to improve this.

In addition, even if individual models are built for each type of image, there is a problem that a process of determining the type of image should be performed first because the type of input image cannot be known beforehand, and that it is difficult to process a new type of image if it is received as input.

The related technologies described above have come to possession of the inventors or acquired by the inventors in the process of deriving the description of the present disclosure, and should not necessarily be considered as a publicly known technology disclosed to the public prior to this application.

### SUMMARY

In order to solve one or more problems (e.g., the problems described above and/or other problems not explicitly described herein), the present disclosure provides an artificial intelligence-based image processing method, apparatus, and computer program using an example image.

In order to solve one or more problems (e.g., the problems described above and/or other problems not explicitly described herein), the present disclosure also provides an artificial intelligence-based image processing method, apparatus, and computer program using an example image, which may input not only input image data to be processed, but also example image data related to processing into an image processing model so that the image processing model processes the input image data in consideration of the example image data, thereby processing various types of image data more reliably without re-training the image processing model.

The artificial intelligence-based image processing method may be performed by a computing device. The artificial intelligence-based image processing method may include acquiring input image data to be processed, acquiring example image data corresponding to the acquired input image data, and generating processed image data corresponding to the acquired input image data by inputting the acquired input image data and the acquired example image data into a pre-trained image processing model.

In one aspect, the acquiring the example image data may include, if one image data is acquired as the input image data, acquiring a plurality of example image data including a plurality of original image data having the same attribute as the acquired one image data, and a plurality of ground truth image data corresponding to the plurality of original image data, and the generating the processed image data may include, in response to inputting the one acquired image data and the plurality of acquired example image data into the image processing model, generating one processed image data corresponding to the one acquired image data.

The acquiring the example image data may include, if one image data is acquired as the input image data, acquiring unit example image data including first unit image data corresponding to a first region of the acquired one image data, and first unit ground truth image data corresponding to the first unit image data, and the generating the processed image data may include, in response to inputting second unit image data corresponding to a second region of the acquired one image data and the acquired first unit example image data into the image processing model, generating second unit processed image data corresponding to the second unit image data.

In one aspect, the acquiring the example image data may include, if video data including a plurality of image frames is acquired as the input image data, acquiring at least one example image frame including at least one of the plurality of image frames and at least one ground truth image frame corresponding to the at least one image frame, and the generating the processed image data may include, in response to inputting the acquired video data and the at least one acquired example image frame into the image processing model, generating a plurality of processed image frames corresponding to each of the plurality of image frames and generating processed video data including the plurality of generated processed image frames.

In one aspect, the acquiring the example image data may include, if a plurality of image data is acquired as the input image data, in response to inputting each of the acquired plurality of image data into the image processing model, generating a plurality of temporary processed image data, and acquiring a plurality of example image data including the plurality of acquired image data and the plurality of generated temporary processed image data.

In one aspect, the acquiring the plurality of example image data may include analyzing the plurality of generated temporary processed image data to extract an indicator related to processing, calculating a score for the plurality of generated temporary processed image data based on the extracted indicator, and acquiring the plurality of example image data using, from the plurality of generated temporary processed image data, temporary processed image data with the calculated scores greater than or equal to a threshold score, or using n temporary processed image data sequentially from the temporary processed image data with the highest calculated scores.

In one aspect, the acquiring the example image data may include, if a plurality of image data is acquired as the input image data, selecting, as example image data, at least one or more image data having the same attribute from the plurality of image data, and the generating the processed image data includes, in response to inputting the at least one selected image data into the image processing model as the example image data and inputting remaining image data excluding the at least one selected image data into the image processing model as the input image data, generating a plurality of processed image data processed in accordance with an attribute of the at least one selected image data.

In one aspect, the image processing model may be a machine learning or deep learning-based model trained according to a supervised learning method using a plurality of image data as input variables and a plurality of processed image data generated by processing each of the plurality of image data as output variables, and the generated processed image data may be image data that includes the acquired input image data with a resolution converted, image data with a contrast difference adjusted, image data with noise removed, or image data with a number of image frames adjusted.

In one aspect, the acquiring the example image data may include determining a number of necessary example image data based on a type of the acquired input image data, and acquiring the determined number of example image data.

In one aspect, the acquiring the example image data may include determining a number of necessary example image data based on a processing level required for the acquired input image data, and acquiring the determined number of example image data.

In one aspect, the acquiring the example image data may include analyzing the acquired input image data to determine a processing difficulty for the acquired input image data, determining the number of necessary example image data based on the determined processing difficulty, and acquiring the determined number of example image data.

In one aspect, the acquiring the example image data may include providing a user interface, and receiving the example image data corresponding to the acquired input image data through the provided user interface.

In one aspect, the acquiring the example image data may include loading at least one example image data corresponding to the acquired input image data from a plurality of example image data pre-stored in a database.

In one aspect, an artificial intelligence-based image processing apparatus may include a processor, a network interface, a memory, and a computer program loaded into the memory and executed by the processor, in which the computer program may include an instruction to acquire input image data to be processed, an instruction to acquire example image data corresponding to the acquired input image data, and an instruction to generate processed image data corresponding to the acquired input image data by inputting the acquired input image data and the acquired example image data into a pre-trained image processing model.

In one aspect, a computer program stored on a computer-readable medium may be combined with a computing device and execute an artificial intelligence-based image processing method including acquiring input image data to be processed, acquiring example image data corresponding to the acquired input image data, and generating processed image data corresponding to the acquired input image data by inputting the acquired input image data and the acquired example image data into a pre-trained image processing model. The artificial intelligence-based image processing method using the example image may be stored on a recording medium readable by a computing device for execution.

The artificial intelligence-based image processing method, apparatus, and computer program using the example image may input not only the input image data to be processed, but also the example image data related to processing into the image processing model so that the image processing model processes the input image data in consideration of the example image data, thereby processing various types of image data more reliably without re-training the image processing model.

The effects of the artificial intelligence-based image processing method, apparatus, and computer program using the example images according to aspects are not limited to those mentioned above, and other effects not mentioned herein can be clearly understood by those skilled in the art from the description below.

### BRIEF DESCRIPTION OF THE DRAWINGS

The preferred aspects of the present disclosure will become more apparent to those of ordinary skill in the art by describing the aspects with reference to the accompanying drawings, in which the drawings are provided to help further understand the technical idea of the present disclosure, and thus the aspects of the disclosure should not be construed as limiting the matters illustrated in the drawings, in which:

FIG. 1 is a diagram illustrating an artificial intelligence-based image processing system using an example image;

FIG. 2 is a diagram illustrating a hardware configuration of an artificial intelligence-based image processing apparatus using an example image;

FIG. 3 is a flowchart provided to explain an artificial intelligence-based image processing method using an example image;

FIG. 4 is a diagram illustrating a process of performing an artificial intelligence-based image processing method using an example image;

FIGS. 5 and 6 are diagrams illustrating an example of a form in which an artificial intelligence-based image processing method using an example image is applied;

FIGS. 7 and 8 are diagrams illustrating a process of processing an image using a related deep learning-based model; and

FIG. 9 is a diagram illustrating a process of processing an image according to an artificial intelligence-based image processing method using an example image.

### DETAILED DESCRIPTION

Various aspects are described herein for the purpose of clearly explaining the technical idea of the present disclosure and are not intended to limit the present disclosure to any specific aspect. The technical idea of the present disclosure includes various modifications, equivalents, alternatives, and aspects selectively combining all or part of each aspect described herein. In addition, the scope of the technical idea of the present disclosure is not limited to the various aspects presented below or detailed descriptions thereof.

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that there may be a second aspect.

The singular forms “a,” “an,” and “the” as used herein are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended to mean that the portion may additionally comprise (or include or have) another component, rather than excluding the same, unless specified to the contrary.

Further, the term “module” or “unit” as used herein refers to a software or hardware component, and the “module” or the “unit” performs certain roles. However, the meaning of the “module” or “unit” is not limited to software or hardware. The “module” or “unit” may be configured to be in an addressable storage medium or configured to execute one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, or variables. Functions provided in the components and the “modules” or “units” may be combined into a smaller number of components and “modules” or “units”, or further divided into additional components and “modules” or “units.”

The “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, etc. Under some circumstances, the “processor” may refer to an application-specific integrated circuit (ASIC), a programmable logic device (PLD), a field-programmable gate array (FPGA), etc. The “processor” may refer to a combination of processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor can read information from and/or write information to the memory. The memory integrated with the processor is in electronic communication with the processor.

Unless otherwise indicated in context, expressions such as “first”, “second”, or “first”, and “second” are used herein to distinguish one object from another among a plurality of homogeneous objects, and these expressions are not intended to limit the order or importance between the objects.

Expressions such as “A, B, and C,” “A, B, or C,” “A, B, and/or C” or “at least one of A, B, and C,” “at least one of A, B, or C,” “at least one of A, B, and/or C,” “at least one selected from A, B, and C,” “at least one selected from A, B, or C,” and “at least one selected from A, B, and/or C” as used herein may refer to each of the listed items or all possible combinations of the listed items. For example, “at least one selected from A and B” may refer to (1) A, (2) at least one of A, (3) B, (4) at least one of B, (5) at least one of A and at least one of B, (6) at least one of A and B, (7) at least one of B and A, (8) both A and B.

Expression “based on” as used herein may be used to describe one or more factors that influence the action or operation of determination or decision described in a phrase or sentence including the expression, and this expression does not exclude additional factors that influence the action or operation of determination or decision.

When it is described that a component (e.g., a first component) is “connected” or

“coupled” to another component (e.g., a second component), it may mean that the component is not only directly connected or coupled to another component, but also connected or coupled through yet another component (e.g., a third component).

Depending on the context, the expression “configured to” as used herein may have meanings such as “set to”, “with the ability to”, “modified to”, “made to”, “able to”, etc. This expression is not limited to mean “specially designed in hardware to”. For example, a processor configured to perform a specific operation may refer to a general-purpose processor that is able to execute software to perform that specific operation.

Hereinafter, various aspects of the present disclosure will be described with reference to the accompanying drawings. In the accompanying drawings and the description of the drawings, the same reference numerals may be assigned to the same or substantially equivalent components. In addition, in the following description of various aspects, overlapping descriptions of the same or corresponding components may be omitted, but this does not mean that the corresponding components are not included in the aspect.

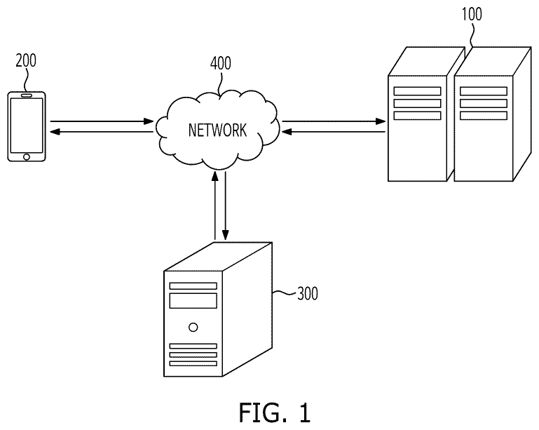

FIG. 1 is a diagram illustrating an artificial intelligence-based image processing system using an example image.

Referring to FIG. 1, the artificial intelligence-based image processing system using the example image may include an artificial intelligence-based image processing apparatus 100 using the example image, a user terminal 200, an external server 300, and a network 400.

It is to be noted that FIG. 1 shows an artificial intelligence-based image processing system using an example image according to a certain aspect, and components of the artificial intelligence-based image processing system are not limited to those illustrated in FIG. 1 and may be added, changed, or deleted as necessary.

The artificial intelligence-based image processing apparatus 100 (hereinafter, “computing device 100”) using the example image may process specific image data using an artificial intelligence-based image processing model to generate processed image data.

The image processing model may be a model trained according to a supervised learning method using a plurality of image data as input variables and a plurality of processed image data generated by processing each of the plurality of image data as output variables.

The image processing model (e.g., neural network) may include one or more network functions, and the one or more network functions may include a set of interconnected computational units, which may generally be referred to as “nodes”. The “nodes” may also be referred to as “neurons”. One or more network functions are configured to include at least one or more nodes. The nodes (or neurons) included in one or more network functions may be interconnected by one or more “links”.

Within the image processing model, one or more nodes connected through the links may form relative relationship of input nodes and output nodes. The concept of input node and output node is relative, such that any node in an output node relationship with respect to one node may be in an input node relationship with another node, and vice versa. As described above, the input node-to-output node relationship may be generated around a link. One or more output nodes may be connected to one input node through the link, and vice versa.

In the input node and output node relationship connected to each other through one link, a value of the output node may be determined based on data input to the input node. A node interconnecting the input node and the output node may have a weight. The weight may be variable and may be varied by a user or an algorithm to allow the image processing model to perform a desired function. For example, if one or more input nodes are interconnected to one output node through respective links, the output node may determine a value of the output node based on the values input to the input nodes connected to the output node and the weights set in the links corresponding to the respective input nodes.

As described above, one or more nodes in the image processing model are interconnected through one or more links to form the input node and output node relationship within the image processing model. The characteristics of the image processing model may be determined according to the number of nodes and links within the image processing model, an association between the nodes and the links, and a weight value assigned to each of the links. For example, if there are two image processing models with the same number of nodes and links and different weight values between the links, the two image processing models may be perceived as different.

Some of the nodes included in the image processing model may form one layer based on distances from the initial input node. For example, a set of nodes with a distance n from the initial input node may form an n-layer. The distance from the initial input node may be defined by the minimum number of links to be traversed to reach a target node from the initial input node. However, the definition of the layer is arbitrary for the purpose of explanation, and the order of the layers within the image processing model may be defined in a different way than that described above. For example, the layer of a node may also be defined by a distance from the final output node.

The initial input node may refer to one or more of the nodes to which data is directly input without passing through a link in a relationship with other nodes within the image processing model. Alternatively, the initial input node may refer to nodes without other input nodes connected thereto through a link in a relationship with the nodes based on the link within the image processing model network. Similarly, the final output node may refer to one or more of the nodes within the image processing model, which do not have an output node in relation to other nodes. In addition, a hidden node may refer to nodes that form the image processing model, except the initial input node and the final output node. The image processing model may have more nodes in the input layer than the nodes in the hidden layer close to the output layer, and may be an image processing model in which the number of nodes decreases from the input layer to the hidden layer.

The image processing model may include one or more hidden layers. A hidden node in the hidden layer may receive, as input, the output from the previous layer and the output from the surrounding hidden node. The number of hidden nodes in each hidden layer may be the same as or different from each other. The number of nodes in the input layer may be determined based on the number of data fields of the input data, and may be the same as or different from the number of hidden nodes. The input data input to the input layer may be calculated by a hidden node in the hidden layer and output by a fully connected layer (FCL) that is an output layer.

In various aspects, the image processing model may be a deep learning model.

The deep learning model (e.g., a deep neural network (DNN)) may refer to an image processing model that includes a plurality of hidden layers in addition to the input layer and the output layer. Using the deep neural network, it may be possible to identify latent structures of data. That is, it is possible to identify the latent structures of photographs, text, videos, speech, and music (e.g., which objects are in the photographs, what are the content and emotions of the text, what are the content and emotions of the speech, etc.).

The deep neural network may include Convolutional Neural Networks (CNNs), Recurrent Neural Network (RNNs), Auto Encoders, Generative Adversarial Networks (GANs), Restricted Boltzmann Machines (RBMs), Deep Belief Networks (DBNs), Q networks, U networks, Siamese networks, etc., but is not limited thereto.

In the present disclosure, the video (or image) refers to a concept that includes both a still image and a moving image, and is not limited to any specific image. In addition, in the present disclosure, image processing may include at least one of converting resolution for images, adjusting contrast differences, removing noise, and adjusting the number of image frames for natural and slow image production, but is not limited thereto.

For example, the image processing model may be a Super-Resolution (SR) model, and if the image processing model is the SR model, the processed image data generated through the SR model may be the resultant image data obtained by converting the resolution of the input image data to a higher resolution.

As another example, the image processing model may be a High Dynamic Range (HDR) model, and if the image processing model is the HDR model, the processed image data generated through the HDR model may be the resultant image data obtained by adjusting the contrast of the input image data.

As another example, the image processing model may be a De-noising model, and if the image processing model is the De-noising model, the processed image data generated through the De-noising model may be the resultant image data obtained by removing noise from the input image data.

As another example, the image processing model may be a frame-rate up conversion (FRUC) model, and if the image processing model is the FRUC model, the processed image data generated through the FRUC model may be the resultant image data obtained by adjusting the number of image frames. However, aspects are not limited to the above.

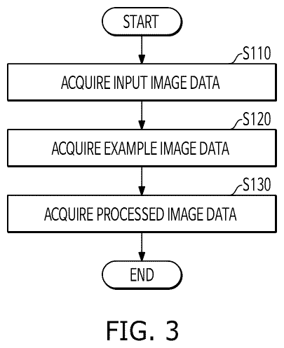

In an aspect, the computing device 100 may input not only the input image data to be processed but also example image data related to the processing method into the image processing model so that the image processing model may process the input image data by referencing the example image data, resulting in more accurate and reliable processed image data being output. This will be described below with reference to FIG. 3.

The computing device 100 may be connected to the user terminal 200 through the network 400, acquire input image data to be processed from the user terminal 200, and provide the processed image data generated through the image processing model to the user terminal 200.

The user terminal 200 may refer to any type of entity (entities) in a system having a mechanism for communicating with the computing device 100. For example, the user terminal 200 may include a personal computer (PC), a note book, a mobile terminal, a smart phone, a tablet PC, a wearable device, etc., and may include all types of terminals that can be connected to a wired/wireless network. In addition, the user terminal 200 may include any computing device implemented by at least one of an agent, an application programming interface (API), and a plug-in. In addition, the user terminal 200 may include an application source and/or a client application.

In addition, the network 400 may refer to a connection structure capable of exchanging information between respective nodes such as a plurality of terminals and servers. For example, the network 400 may include a local area network (LAN), a wide area network (WAN), the Internet (WWW), a wired/wireless data network, a telephone network, a wired/wireless television network, a controller area network (CAN), Ethernet, etc.

Wireless data communication networks may include 3G, 4G, 5G, 3rd generation partnership project (3GPP), long term evolution (LTE), 5G NR (New Radio), 6G, world interoperability for microwave access (WIMAX), Wi-Fi, Internet, wireless local area network (LAN), wide area networks (WANs), personal area networks (PAN), radio frequency (RF), Bluetooth networks, near-field communication (NFC) networks, satellite broadcasting networks, analog broadcasting networks, digital multimedia broadcasting (DMB) networks, etc., but are not limited thereto.

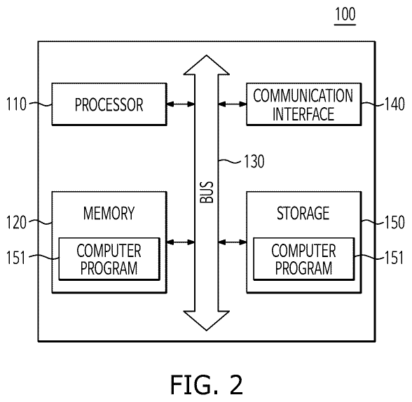

The external server 300 may be connected to the computing device 100 through the network 400, store and manage information and data necessary for the computing device 100 to perform various processes, or receive and manage information and data derived as the computing device 100 performs various processes. For example, the external server 300 may be a storage server separately provided outside the computing device 100, but is not limited thereto. A hardware configuration of the computing device 100 will be described with reference to FIG. 2.

FIG. 2 is a diagram illustrating a hardware configuration of an artificial intelligence- based image processing apparatus using an example image.

Referring to FIG. 2, the computing device 100 according to another aspect may include one or more processors 110, a memory 120 that loads a computer program 151 to be executed by the processor 110, a bus 130, a communication interface 140, and a storage 150 that stores the computer program 151. FIG. 2 shows only the components related to one aspect. Accordingly, those of ordinary skill in the art to which the present disclosure pertains will be able to recognize that other general-purpose components may be further included in addition to the components illustrated in FIG. 2.

The processor 110 controls the overall operation of each component of the computing device 100. The processor 110 may be configured to include a central processing unit (CPU), a micro processor unit (MPU), a micro controller unit (MCU), a graphic processing unit (GPU), or any type of processor well known in the technical field of the present disclosure.

In addition, the processor 110 may perform computation on at least one application or program for executing a method according to one aspect of the present disclosure, and the computing device 100 may include one or more processors.

In various aspects, the processor 110 may further include a random access memory (RAM) and a read-only memory (ROM) for temporarily and/or permanently storing signals (or data) processed within the processor 110. In addition, the processor 110 may be implemented in the form of a system on chip (SoC) that includes at least one of a graphics processing unit, RAM, and ROM.

The memory 120 stores various data, commands and/or information. The memory 120 may load the computer program 151 from the storage 150 to execute a method/operation according to various aspects of the present disclosure. If the computer program 151 is loaded into the memory 120, the processor 110 may perform the method/operation by executing one or more instructions of the computer program 151. The memory 120 may be implemented as a volatile memory such as RAM, but the technical scope of the present disclosure is not limited thereto.

The bus 130 provides a communication function between components of the computing device 100. The bus 130 may be implemented as various types of buses including an address bus, a data bus, a control bus, etc.

The communication interface 140 supports wired/wireless Internet communication of the computing device 100. In addition, the communication interface 140 may support various other communication methods in addition to the Internet communication. To this end, the communication interface 140 may include a communication module well known in the technical field of the present disclosure. In some aspects, the communication interface 140 may be omitted.

The storage 150 may non-temporarily store the computer program 151. If the artificial intelligence-based image processing process is performed through the computing device 100 using the example image, the storage 150 may store various information necessary to provide an artificial intelligence-based image processing process using the example image.

The storage 150 may include a non-volatile memory such as a read only memory (ROM), an erasable programmable ROM (EPROM), an electrically erasable programmable ROM (EEPROM), a flash memory, etc., a hard disk, a removable disk, or any type of computer-readable recording medium well known in the art to which the present disclosure pertains.

The computer program 151 may include one or more instructions that, upon loading into the memory 120, cause the processor 110 to perform a method/operation according to various aspects of the present disclosure. That is, the processor 110 may execute the one or more instructions to perform the method/operation according to various aspects of the present disclosure.

The computer program 151 may include one or more instructions for performing an artificial intelligence-based image processing method using the example image, in which the method may include acquiring input image data to be processed, acquiring example image data corresponding to the acquired input image data, and in response to inputting the acquired input image data and the acquired example image data into a pre-trained image processing model, generating processed image data corresponding to the acquired input image data.

The steps of the method or algorithm described in connection with an aspect of the present disclosure may be implemented directly in hardware, or as a software module executed by the hardware, or by a combination thereof. The software module may be stored in random access memory (RAM), read only memory (ROM), erasable programmable ROM (EPROM), electrically erasable programmable ROM (EEPROM), flash memory, hard disk, removable disk, CD-ROM, or any form of computer-readable recording medium well known in the technical field to which the present disclosure pertains.

The components of the aspect of the disclosure may be implemented as a program (or application) that may be combined with hardware, such as a computer, for execution and stored on a medium. The components of the present disclosure may be executed by software programming or software elements, and likewise, aspects may be implemented in a programming or scripting language such as C, C++, Java, and assembler, including various algorithms implemented in a data structure, processes, routines, or a combination of other programming configurations. Functional aspects may be implemented as algorithms executed on one or more processors. The artificial intelligence-based image processing method using the example image performed by the computing device 100 will be described with reference to FIG. 3.

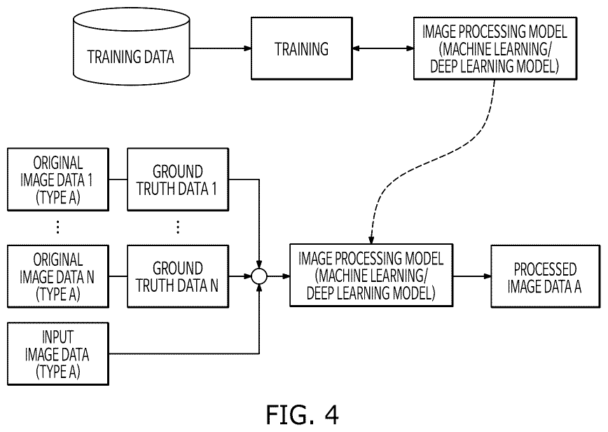

FIG. 3 is a flowchart provided to explain the artificial intelligence-based image processing method using the example image, and FIG. 4 is a diagram illustrating a process of performing the artificial intelligence-based image processing method using an example image.

Referring to FIGS. 3 and 4, the computing device 100 may acquire input image data to be processed, at S110.

The computing device 100 may acquire the input image data to be processed from the user terminal 200. For example, the computing device 100 may be connected to the user terminal 200 through the network 400, provide a user interface (UI) to the user terminal 200, and receive image data to be processed from the user through the UI. However, aspects are not limited thereto, and various methods of acquiring image data may be applied. For example, the computing device 100 may be directly connected to a camera to acquire image data captured through the camera as the image data to be processed, but aspects are not limited thereto.

The input image data may include one or more image data, but is not limited thereto, and may include multiple image data or video data including multiple image frames.

At S120, the computing device 100 may acquire example image data corresponding to the input image data acquired at S110.

The example image data may be data related to an example of a processing task to be performed on the input image data, and may be data including, for example, a pair including original image data with the same attributes (e.g., type, resolution, quality, etc.) as the input image data to be processed and ground truth image data generated by processing the original image data.

For example, for a resolution conversion task to be performed on the input image data, the example image data may include a pair including original image data having the same attributes as the input image data and ground truth image data derived from converting the resolution of the original image data.

As another example, for a noise removal task to be performed on the input image data, the example image data may include a pair including original image data having the same attribute as the input image data and ground truth image data derived from removing noise included in the original image data.

As yet another example, for a quality improvement task to be performed on the input image data, the example image data may include a pair including original image data having the same attribute as the input image data and ground truth image data derived from improving the quality of the original image data.

The computing device 100 may directly acquire the example image data from a user. For example, the computing device 100 may provide a user interface to the user terminal 200 and receive example image data corresponding to input image data through the user interface.

If input image data to be processed is acquired, the computing device 100 may load at least one example image data corresponding to the input image data from a plurality of example image data pre-stored in the database. The computing device 100 may load, as the example image data, the image data from the plurality of example image data pre-stored in the database, in which the loaded image data may be of the same type as the input image data, and may include image data previously processed by the processing task to be performed on the input image data, and original image data corresponding to the image data.

If one image data is acquired as the input image data, the computing device 100 may acquire a plurality of example image data including a plurality of original image data having the same attribute (e.g., type, resolution, quality, etc.) as the one image data, and a plurality of example processed image data corresponding to the plurality of original image data. For example, if it is required to process input image data of type A as illustrated in FIG. 4, the computing device 100 may acquire a plurality of example image data including pairs of a plurality of original image data of type A and a plurality of ground truth image data derived from processing each of the plurality of original image data.

If one image data is acquired as the input image data, the computing device 100 may acquire a pair including image data before and after processing at least a portion of the one image data as unit example image data. For example, if one image data is acquired as the input image data, the computing device 100 may acquire unit example image data including first unit image data corresponding to a first region of the image data and first unit ground truth image data corresponding to the first unit image data. For example, in order to perform the resolution conversion task on one image data, the computing device 100 may acquire, as the unit example image data, a pair including unit image data before and after the resolution conversion is performed on at least a portion of one image data.

If video data including a plurality of image frames is acquired as the input image data, the computing device 100 may acquire at least one example image frame including at least one of the plurality of image frames and at least one ground truth image frame corresponding to the at least one image frame. For example, in order to perform the resolution conversion task on video data, the computing device 100 may acquire, as an example image frame, a pair including an image frame obtained from capturing a specific scene in a low resolution and an image frame obtained from capturing the specific scene in a high resolution, among the plurality of image frames included in the video data.

If a plurality of image data is acquired as input image data, the computing device 100 may input each of the plurality of image data into the image processing model to generate a plurality of temporary processed image data, and acquire, as a plurality of example image data, a pair including a plurality of image data and a plurality of temporary processed image data corresponding to each of the plurality of image data.

In this case, the computing device 100 may acquire a plurality of example image data using only at least one of the plurality of temporary processed image data. For example, the computing device 100 may analyze the plurality of temporary processed image data to extract an indicator related to the processing, calculate scores for the plurality of temporary processed image data based on the calculated indicator, acquire a plurality of example image data using only temporary processed image data with scores greater than or equal to a threshold score, or acquire a plurality of example image data sequentially using only n temporary processed image data starting from the temporary processed image data with the highest score.

For example, if the temporary processed image data is image data derived from converting the resolution of the image data to a higher resolution, the computing device 100 may calculate pixel-based evaluation indicator for the temporary processed image data, calculate a score for the resolution conversion quality based on the calculated indicator, and acquire example image data using only the temporary processed image data in the appropriately converted resolution based on the calculated score.

The pixel-based evaluation metric refers to a pixel-by-pixel difference between image data and image data in the converted resolution, and may be, for example, a mean squared error (MSE) and a peak signal-to-noise ratio (PSNR), but is not limited thereto.

If a plurality of image data is acquired as input image data, the computing device 100 may select at least one image data having the same attribute from the plurality of image data as example image data. For example, the computing device 100 may select image data having the same resolution or same quality from the plurality of image data as example image data, but aspects are not limited thereto.

The computing device 100 may determine the number of necessary example image data based on the type of input image data, and acquire the determined number of example image data. For example, the computing device 100 may store the number of required example image data for each type of image data in advance, and may determine the number of required example image data corresponding to the type of image data to be processed based on the information stored in advance.

The type of image data may refer to a type of an object included in the image data, and may be classified as follows, although aspects are not limited thereto.

### 1. Major Categories

Natural; Landscapes, animals, plants, etc.
Man-made; Buildings, vehicles, appliances, etc.
People; Human faces or full bodies

### 2. Middle Categories

Natural—Landscapes; Mountains, seas, rivers, waterfalls, etc.
Natural—Animals; Mammals, birds, amphibians, etc.
Natural—Plants; Flowers, trees, grass, etc.
Man-made—Buildings; Houses, commercial buildings, public facilities, etc.
Man-made—Vehicles; Cars, bicycles, buses, etc.
Man-made—Home Appliances; Computers, refrigerators, televisions, etc.
People—Faces; Faces of individuals with various expressions
People—Full Bodies; Images showing the full body of a person

### 3. Subcategories

Natural—Landscapes—Mountains; Specific mountain terrains
Natural—Animals—Mammals: Cats, puppies, tigers, etc.
Natural—Plants—Flowers; Roses, tulips, lilies, etc.
Man-made—Buildings—Houses; Residential buildings
Man-made—Vehicles—Cars; Cars, trucks, motorcycles, etc.
Man-made—Home Appliances—Computers; Laptops, desktops, etc.
People—Faces-Happy Expressions; Smiling face
People—Full Bodies-Sports; Athletic person

The computing device 100 may determine the number of required example image data based on a processing level required for the input image data, and acquire the determined number of example image data. For example, the computing device 100 may be designed to acquire more example image data as the processing level required for the input image data increases.

The processing level may be an indicator of the extent of a processing task to be performed. For example, for a resolution conversion task performed on the input image data, the processing level may be a required resolution conversion level for the input image data, but aspects are not limited thereto.

The computing device 100 may analyze the input image data to determine a processing difficulty of the acquired input image data, determine the number of necessary example image data based on the processing difficulty, and acquire the determined number of example image data. For example, the computing device 100 may be designed to acquire more example image data as the processing difficulty of the processing task required for the input image data increases.

The processing difficulty may be determined based on various criteria such as type of image data, type of object included in the image data, number of objects included in the image data, etc., but aspects are not limited thereto.

At S130, the computing device 100 may input the input image data acquired at S110 and the example image data acquired at S120 into the image processing model to generate processed image data corresponding to the input image data.

For one image data, if a plurality of example image data corresponding to the one image data are acquired, the computing device 100 may input the one image data and the plurality of example image data into the image processing model, thereby generating one processed image data derived from processing the one image data based on the plurality of example image data.

For one image data, if the unit example image data including the first unit image data corresponding to the first region of the one image data and the first unit example processed image data corresponding to the first unit image data are acquired, the computing device 100 may input the second unit image data and the unit example image data corresponding to the second region of the one image data into the image processing model, thereby generating second unit processed image data derived from processing the second unit image data based on the first unit example image data. That is, for one image data, the computing device 100 may input the image data of a specific region of the one image data before and after processing into the image processing model as the example image data, allowing the processing task on the remaining region to be performed in consideration of the specific region before and after processing.

For video data including a plurality of image frames, if at least one example image frame including at least one image frame and at least one ground truth image frame corresponding to the at least one image frame is acquired, the computing device 100 may input the video data and the at least one example image frame into the image processing model to generate a plurality of processed image frames that are derived by processing the remaining image frames based on the at least one example image frame, thereby generating processed image data including a plurality of processed image frames. That is, among a plurality of image frames, the computing device 100 may input an image frame of a specific image frame before and after processing into the image processing model as an example image frame, allowing the processing task on the remaining image frames to be performed in consideration of the specific image frame before and after processing.

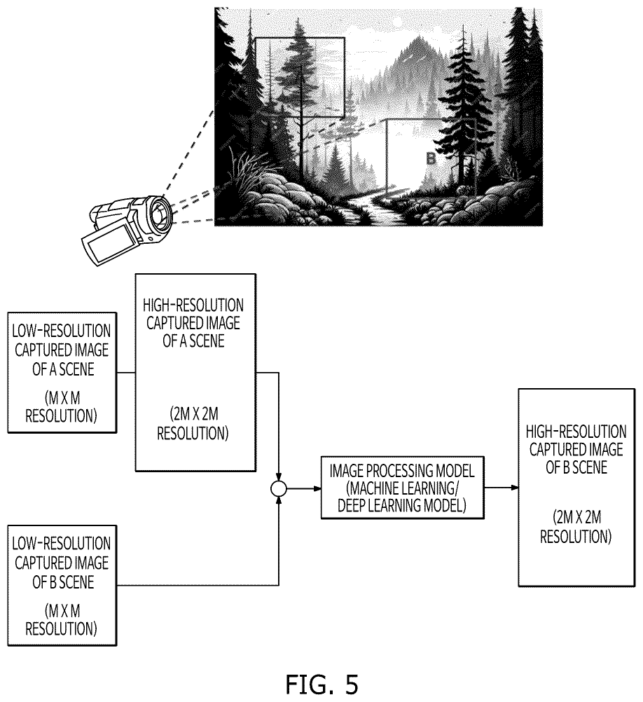

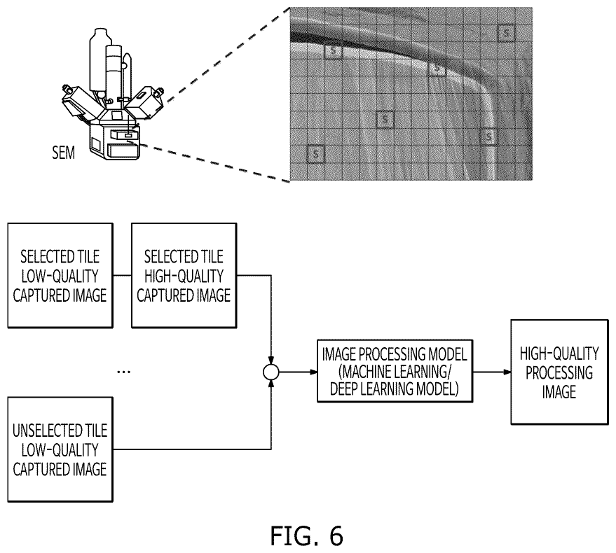

For a plurality of image data, if at least one or more image data having the same attribute is selected from the plurality of image data as example image data, the computing device 100 may input the at least one or more image data into the image processing model as the example image data, and input the remaining image data excluding the at least one or more image data into the image processing model as the input image data, thereby generating a plurality of processed image data derived by processing the remaining image data based on the at least one or more image data. That is, among the plurality of image data, the computing device 100 may input the image data of a specific image data before and after processing into the image processing model as the example image data, allowing the processing task on the remaining image data to be performed in consideration of the specific image data before and after processing. Hereinbelow, a form in which the artificial intelligence-based image processing method using the example image is applied will be described in more detail with reference to FIGS. 5 and 6.

FIGS. 5 and 6 are diagrams illustrating an example of a form in which the artificial intelligence-based image processing method using the example image is applied.

First, referring to FIG. 5, the artificial intelligence-based image processing method using the example image may be applied to the resolution conversion task on the image data.

As illustrated in FIG. 5, a low-resolution captured image (first unit image data) of A Scene and a high-resolution captured image (first unit ground truth image data) of A Scene may be input into the image processing model (SR model) as the unit example image data, along with a low-resolution captured image of B Scene, so that the image processing model may process the low-resolution captured image of B Scene by referencing the low-resolution captured image of A Scene and the high-resolution captured image of A Scene, thereby generating a high-resolution captured image of B Scene.

In general, capturing a high-resolution image is challenging due to factors such as long exposure times or extended processing times resulting from difficulty in image processing, but according to some aspects, the artificial intelligence-based image processing method using the example image provides an advantage that it is possible to easily acquire the high-resolution captured image with relatively fewer resources.

In addition, based on the principle described above, an image without noise removal and an image with noise removal for a specific region may be input into the image processing model (De-noising model) as the unit example image data, along with an image of another region, so that the image processing model may remove noise included in the image corresponding to the other region by referencing the image without noise removal and the image with noise removal for the specific region.

In addition, an image without contrast difference adjustment and an image with contrast difference adjustment for a specific region may be input into the image processing model (HDR model) as the unit example image data, along with an image of another region, so that the image processing model may adjust the contrast difference between the image corresponding to the other region by referencing the image without contrast difference adjustment and the image with contrast difference adjustment for the specific region.

As described above, with the artificial intelligence-based image processing method using the example image according to some aspects, even when an object to be captured is changed, the image processing model is applicable without requiring additional training, and it is possible to process various types of image data (e.g., portraits, natural landscapes, urban scenery, artworks, sports events, indoor photography, etc.) through one image processing model.

Referring to FIG. 6, the artificial intelligence-based image processing method using the example image may also be used for capturing a microscope/electron microscope. For example, only a specific part of an image frame captured through a microscope/electron microscope may be captured in low and high resolutions and used as an example image frame, so that the remaining parts except for the specific part may be converted to a higher resolution, like the specific part.

Typically, it takes a long time to acquire a high-quality image, but with the artificial intelligence-based image processing method using the example image according to some aspects, it is possible to acquire the entire high-quality image by selectively capturing a high-quality image for at least a part of the image and thus acquire a high-quality image in a short period of time.

In addition, based on the principle described above, the image before and after noise removal for a specific part in one image frame captured through a microscope/electron microscope may be used as an example image frame, so that a noise removal task may be performed on the remaining parts except for the specific part.

In addition, the image before and after the contrast difference adjustment for the specific part in the one image frame captured through a microscope/electron microscope may be used as the example image frame, so that the contrast difference adjustment task may be performed for the remaining parts except for the specific part.

As described above, there is an advantage that the artificial intelligence-based image processing method using the example image according to some aspects is able to efficiently work on various types of input images such as cells of living organisms, minerals, proteins, semiconductors, because it is possible to process various types of objects through one image processing model.

In addition, if there are results obtained from capturing images of the same object through different types of sensors or through sensors driven by different measurement methods, the artificial intelligence-based image processing method using the example image according to some aspects may use the result (e.g., high-cost measurement result) obtained from capturing through a specific sensor as an example to process the results (e.g., low-cost measurement results) obtained from capturing through the remaining sensors, resulting in an environment in which high results are obtained at low cost.

In addition, the aspects are applicable not only to microscope/electron microscopes, but also to image data captured through various image measurement equipment such as general cameras, telescopes, etc.

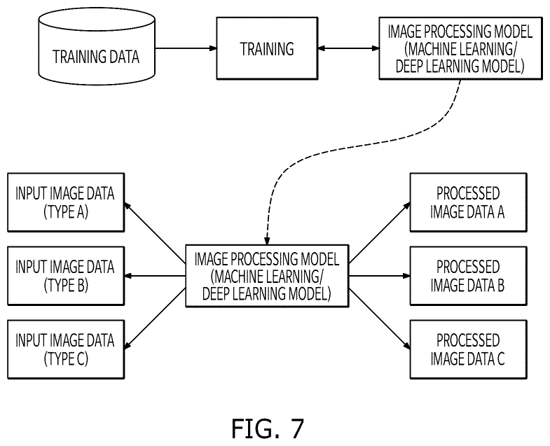

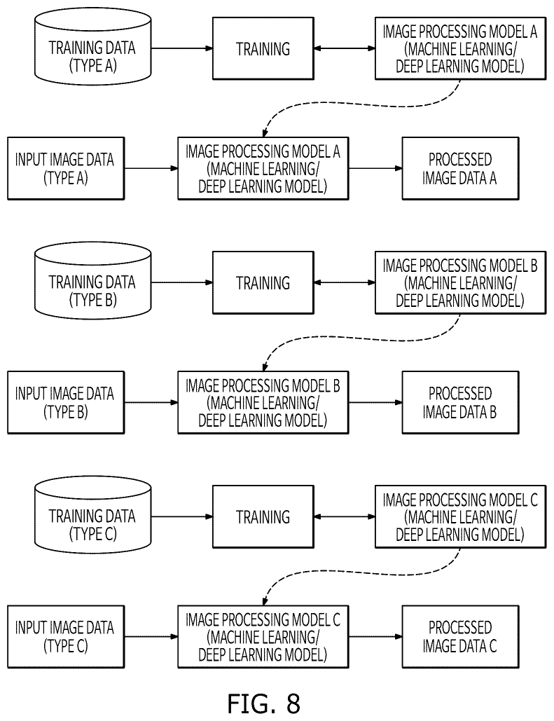

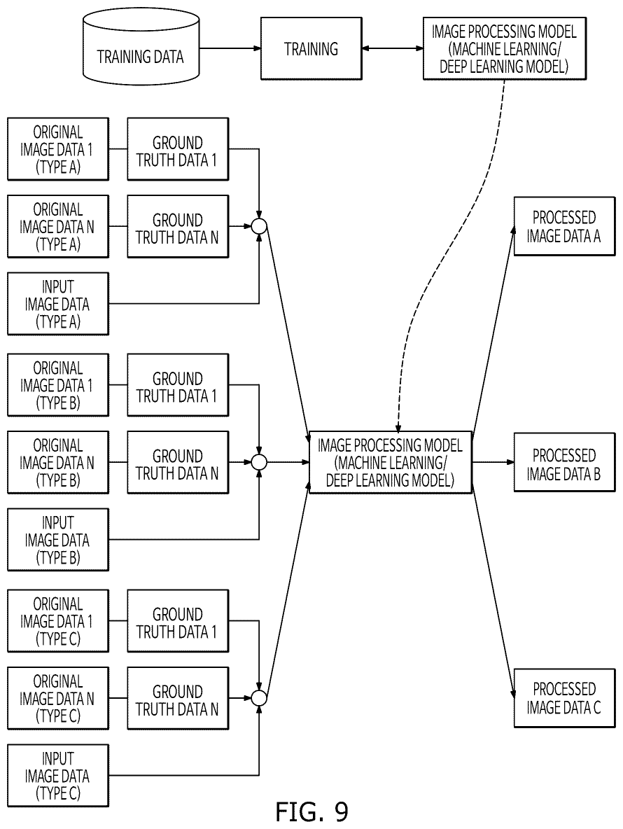

FIGS. 7 and 8 are diagrams illustrating a process of processing an image using a related deep learning-based model, and FIG. 9 is a diagram illustrating a process of processing an image according to the artificial intelligence-based image processing method using the example image.

As illustrated in FIG. 7, the related deep learning-based model is trained through supervised learning using, as training data, the original image data and the result of processing the original image data, but there is a problem that it is difficult to process all images with high performance if input images of different types have to be processed.

In order to improve this problem, as illustrated in FIG. 8, a method of constructing individual models for each type of image and process the images according to the type of input image by using one of a plurality of models that corresponds to the type of image has been used.

However, the above method has a problem that it is not known in advance which type of image will be input during actual service operation, and it is difficult to process if a new type of image is received as an input.

On the other hand, there is an advantage that the artificial intelligence-based image processing method using the example image is able to process various types of images with only one image processing model, and produce reliable results regardless of the type of image by inputting not only the input image data to be processed, but also the example image data for the processing task to be performed on the input image data, as illustrated in FIG. 9.

As described above, a person skilled in the art to which the present disclosure pertains will be able to understand that the present disclosure may be implemented in other specific forms without changing its technical idea or essential features. Therefore, the aspects described above should be understood as illustrative and non-limiting in all respects. The scope of the present disclosure should be represented by the claims described below rather than detailed description, and all changes or modifications derived from the meaning and scope of the claims and the equivalent concept should be construed as being included in the scope of the present disclosure.

The features and advantages described herein do not include all possibilities, and in particular, many additional features and advantages will be apparent to those skilled in the art in consideration of the drawings, description, and claims. Moreover, it should be noted that the language used herein has been selected primarily for easy-to-read and teaching purposes, and may not be selected to describe or limit the subject matter of the present disclosure.

The above description of the aspects of the present disclosure is presented for illustrative purposes. It is not intended to limit this disclosure to the exact form described herein or to create this disclosure without any omission. Those skilled in the art can understand that many modifications and variations are possible in light of the aspects described above.

Therefore, the scope of this disclosure is not limited by the detailed description, but is limited by any claims of the application based on it. Therefore, the disclosure of the aspects of the present disclosure is exemplary and does not limit the scope of the present disclosure described in the following claims.

1. A method performed by a computing device, comprising:
acquiring input image data to be processed;
acquiring example image data corresponding to the acquired input image data; and
generating processed image data corresponding to the acquired input image data by inputting the acquired input image data and the acquired example image data into a pre-trained image processing model.

2. The method according to claim 1, wherein:
the acquiring the example image data comprises based on first image data being acquired as the input image data, acquiring a plurality of pieces of first example image data, wherein the plurality of pieces of first example image data comprises a plurality of original image data and a plurality of ground truth image data corresponding to the plurality of original image data, and wherein the plurality of original image data and the acquired first image data have a same attribute; and
the generating the processed image data comprises in response to inputting the acquired first image data and the plurality of pieces of first example image data into the image processing model, generating first processed image data corresponding to the acquired first image data.

3. The method according to claim 1, wherein:
the acquiring the example image data comprises based on first image data being acquired as the input image data, acquiring unit example image data, wherein the unit example image data comprises: first unit image data corresponding to a first region of the acquired first image data, and first unit ground truth image data corresponding to the first unit image data; and
the generating the processed image data comprises in response to inputting second unit image data corresponding to a second region of the acquired first image data and the acquired unit example image data into the image processing model, generating second unit processed image data corresponding to the second unit image data.

4. The method according to claim 1, wherein:
the acquiring the example image data comprises based on video data including a plurality of image frames being acquired as the input image data, acquiring at least one example image frame, wherein the at least one example image frame comprises at least one of the plurality of image frames and at least one ground truth image frame corresponding to the at least one of the plurality of image frames; and
the generating the processed image data comprises in response to inputting the acquired video data and the acquired at least one example image frame into the image processing model, generating a plurality of processed image frames each corresponding to one of the plurality of image frames and generating processed video data comprising the plurality of generated processed image frames.

5. The method according to claim 1, wherein the acquiring the example image data comprises:
based on a plurality of image data being acquired as the input image data and based on inputting each of the acquired plurality of image data into the image processing model, generating a plurality of temporary processed image data; and
acquiring a plurality of example image data including the plurality of acquired image data and the plurality of generated temporary processed image data.

6. The method according to claim 5, wherein the acquiring the plurality of example image data comprises:
extracting, based on the plurality of generated temporary processed image data, an indicator related to processing;
determining, based on the extracted indicator, a score for each of the plurality of generated temporary processed image data; and
acquiring the plurality of example image data using, from the plurality of generated temporary processed image data, temporary processed image data with the scores greater than or equal to a threshold score, or using n temporary processed image data sequentially from the temporary processed image data with a highest score.

7. The method according to claim 1, wherein:
the acquiring the example image data comprises based on a plurality of image data being acquired as the input image data, selecting, as the example image data, at least one image data having a same attribute from the plurality of image data; and
the generating the processed image data comprises in response to inputting the at least one selected image data into the image processing model as the example image data and inputting remaining image data excluding the at least one selected image data into the image processing model as the input image data, generating a plurality of processed image data processed in accordance with an attribute of the at least one selected image data.

8. The method according to claim 1, wherein
the image processing model is a machine learning-based model or a deep learning-based model trained according to a supervised learning method using a plurality of sample image data as input variables and a plurality of processed sample image data, generated by processing each of the plurality of sample image data, as output variables, and
the generated processed image data is image data that comprises the acquired input image data with a resolution being converted, image data with a contrast difference being adjusted, image data with noise being removed, or image data with a number of image frames being adjusted.

9. The method according to claim 1, wherein the acquiring the example image data comprises:
determining a number of necessary example image data based on a type of the acquired input image data; and
acquiring the determined number of example image data.

10. The method according to claim 1, wherein the acquiring the example image data comprises:
determining a number of necessary example image data based on a processing level required for the acquired input image data; and
acquiring the determined number of example image data.

11. The method according to claim 1, wherein the acquiring the example image data comprises:
determining, based on the acquired input image data, a processing difficulty level for the acquired input image data;
determining a number of necessary example image data based on the determined processing difficulty level; and
acquiring the determined number of example image data.

12. The method according to claim 1, wherein the acquiring the example image data comprises:
providing a user interface; and
receiving the example image data corresponding to the acquired input image data via the provided user interface.

13. The method according to claim 1, wherein the acquiring the example image data comprises loading at least one example image data corresponding to the acquired input image data from a plurality of example image data pre-stored in a database.

14. An image processing apparatus, comprising:
a processor;
a network interface; and
a memory storing a computer program, when executed by the processor, configured to cause the image processing apparatus to:
acquire input image data to be processed;
acquire example image data corresponding to the acquired input image data; and
generate processed image data corresponding to the acquired input image data by inputting the acquired input image data and the acquired example image data into a pre-trained image processing model.

15. A non-transitory computer-readable medium storing instructions that, when executed by a computing device, cause:
acquiring input image data to be processed;
acquiring example image data corresponding to the acquired input image data; and
generating processed image data corresponding to the acquired input image data by inputting the acquired input image data and the acquired example image data into a pre-trained image processing model.
